(19) United States
(12) Patent Application Publication
(10) Pub. No.: US 2005/0113967 A1
(43) Pub. Date: May 26, 2005

(54) Tablet sensing system and control method for drug dispensing apparatus

(75) Inventor: Jun-ho Kim, Dalseo-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: JVM CO., LTD, Daegu (KR)

(21) Appl. No.: 10/948,238

(22) Filed: Sep. 24, 2004

(30) Foreign Application Priority Data
Sep. 25, 2003 (KR) 2003-66702

(51) Int. Cl. G06F 17/00; G07F 11/00

(52) U.S. Cl. 700/236; 221/6

(57) ABSTRACT

Disclosed is a tablet sensing system for a drug dispensing apparatus for sensing and counting tablets when the tablets are discharged from tablet cassettes. The tablet sensing system maintains optical receipt sensitivity such that tablet discharge is precisely conducted by setting initial reference values of a level of signal for light emitted from a light emitting device for determining the change of the amount of light without resetting reference values for determining whether tablets are discharged or not, detects an output level of the optical signal from the light emitting device by means of a light receiving device before the tablets are discharged to determine whether the amount of light is varied or not based on the set initial reference values, and adjusts the output level of the optical signal by compensating the amount of light emitted from the light emitting means by an amount of change of light.

### BACKGROUND OF THE INVENTION

1. Field of the Invention

The present invention relates to a drug dispensing apparatus, and more particularly to a tablet sensing system of the drug dispensing apparatus for sensing and counting tablets when the tablets are discharged from tablet cassettes.

2. Description of the Related Art

In general, a tablet auto-dispensing and packing apparatus is an apparatus which automatically selects tablets prescribed based on the kind of disease of a patient to pack the selected tablets for each dose. This apparatus includes a plurality of tablet cassettes containing various kinds of tablets and arranged on a drug storage shelf. The plurality of tablet cassettes arranged on the drug storage shelf are intermittently controlled such that tablets prescribed dose by dose are discharged to a hopper at a lower side of the drug storage shelf through respective passages formed in the drug storage shelf. Then, the discharged tablets collected in the hopper are packed by packing papers in a packing apparatus.

In such an auto-dispensing and packing apparatus, different kinds of tablets are accommodated in respective tablet cassettes arranged on the drug storage shelf. The tablet cassettes are intermittently controlled, according to a prescription, such that the tablets accommodated in the tablet cassettes are discharged from the tablet cassettes.

FIG. 1 is a sectional view illustrating an example of configuration of a general tablet cassette showing tablet discharge.

Referring to FIG. 1, a motor 2 is rotated under control of a control means 1, and, accordingly, the tablets accommodated in the tablet cassette are discharged to a discharge passage 5 of a mounting plate through an outlet 4 while rotor 3 coupled on a rotation axis of the motor 2 is rotated.

A tablet sensing means provided on the outlet 4 of the tablet cassette counts the tablets discharged through the outlet 4 and determines whether the tablets are precisely discharged according to a control command. Based on the determination, the control means generates a tablet cassette alarm such that a system operator can perform supplementation and checking of tablets.

The tablet sensing means is composed of an infrared light emitting device and an infrared light receiving device. These devices are configured such that infrared light passes the outlet 4 transversely to detect the discharged tablets.

However, considering that the tablet auto-dispensing and packing apparatus is an apparatus for discharging tablets as drugs, since photosensitivity of the infrared light receiving device may be deteriorated due to drug dust remaining in the outlet 4 when the tablets are discharged, the tablets may be incorrectly detected, which leads to malfunction (wrong alarm) of the apparatus.

Namely, in spite of the fact that the tablets have already been discharged, it may be determined that the tablets are not discharged, and accordingly, a tablet supplementation alarm can be generated.

Accordingly, in consideration of the deterioration of photosensitivity due to drug dust, a variety of methods for discharging the tablets precisely without leaving drug dust in the outlet have been proposed.

An example of these methods is disclosed in Korean Patent Application No. 2001-7013105. This patent application discloses a technique where discharge of the tablets is detected based on two reference values, i.e., a first reference value V₁ and a second reference value V₂, as shown in FIG. 2. More specifically, when a discharge event of the tablets occurs, a control means perceives a level of an optical signal outputted from a light emitting device and sensed by a light receiving device before the tablets are discharged, and sets the two reference values based on the perceived level. As mentioned above, the two reference values include the first reference value V₁ and the second reference value V₂. The first reference value V₁ is defined to be 90% of the level of the optical signal and the second reference value V₂ is defined to be 80% of the output level of the optical signal.

Accordingly, after the motor 2 is driven to discharge the tablets, if the level of the optical signal outputted from the light emitting device and sensed by the light receiving device drops below the first reference value V₁, it is determined that the tablets are in a state before they pass through the outlet, or if the output level of the optical signal is raised above the second reference value V₂, it is determined that the tablets are in a state after they pass through the outlet.

Accordingly, even if the output level of the optical signal detected by the light receiving device drops due to contamination caused by drug dust as shown in FIG. 3, sensing precision of the tablet discharge can be raised by resetting the first reference value V₁ and the second reference value V₂ for sensing the tablet discharge in a contaminated state before the tablet discharge.

However, in such a conventional tablet discharging and sensing method, only reference values for determining whether the tablets are discharged or not are altered without changing the optical signal for sensing the tablets before the tablets are discharged. Accordingly, the sensitivity of the light receiving device is deteriorated when the contamination caused by drug dust becomes slightly more serious, which may result in higher frequency of wrong alarm of the apparatus.

### SUMMARY OF THE INVENTION

Therefore, it is an object of the present invention to provide a tablet discharge sensing apparatus and a control method thereof, which is capable of maintaining optical receipt sensitivity constant such that the tablet discharge is precise by setting initial reference values of a signal level for light emitted from a light emitting device for determining the change of the amount of light without resetting reference values for determining whether tablets are discharged or not, detecting an output level of the optical signal from the light emitting device by means of a light receiving device before the tablets are discharged to determine whether the amount of light is varied or not based on the set initial reference values, and adjusting the output level of the optical signal to compensate for the amount of light emitted from the light emitting means by the amount of change of light.

In accordance with an aspect of the present invention, the above and other objects can be accomplished by the provision of a tablet discharge sensing apparatus including a tablet discharge means for discharging tablets contained in a container, a motor for driving the tablet discharge means, and a control means for controlling the motor of a corresponding tablet cassette to discharge the tablets when a tablet discharge event occurs, wherein the tablet discharge sensing apparatus further comprises an optical sensing means including a light emitting device and a light receiving device for outputting an optical signal to a tablet outlet and detecting the optical signal received through the tablet outlet, a light amount adjustment means for determining the amount of change of light by way of a comparison between an output level of the optical signal detected by the optical sensing means and an initial reference value of a preset output level of the optical signal, and adjusting the output level of the optical signal from the light emitting device by the amount of change of light, and a tablet discharge sensing means for determining whether the tablets are discharged or not by comparing the output level of the optical signal detected by the optical sensing means with a set reference level, and wherein the control means controls the tablet discharge after automatically adjusting the output level of the optical signal from the light emitting device through the tablet discharge sensing means when the tablet discharge event occurs.

In accordance with another aspect of the present invention, the above and other objects can be accomplished by the provision of a tablet discharge sensing control method comprising the steps of:

detecting a level of an optical signal emitted from a light emitting device of a corresponding tablet cassette and received in a light receiving device when a tablet discharge event occurs,

determining the change of the amount of light by comparing the level of the optical signal detected by the light receiving device with an initial reference value of a level of the optical signal emitted from the light emitting device,

adjusting the amount of light emitted from the light emitting device to compensate for the change of the amount of light by adjusting a duty cycle of a pulse supplied to the light emitting device based on the initial reference value when the amount of light is changed, and

sensing the tablet discharge by driving a motor to discharge the tablets and determining whether the tablets are discharged or not by comparing the level of the optical signal detected by the light receiving device with a preset reference value.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating structure of a tablet cassette of a conventional tablet auto-dispensing apparatus;

FIG. 2 is a waveform diagram for explaining a method for discharging tablets based on an optical signal sensed by a photosensor in a tablet discharge sensing method of the conventional tablet auto-dispensing apparatus;

FIG. 3 is a waveform diagram for explaining a method for discharging tablets based on an optical signal sensed by a photosensor, after a tablet discharging outlet is contaminated, in a tablet discharge sensing method of the conventional tablet auto-dispensing apparatus;

FIG. 4 is a block diagram illustrating an embodiment of a tablet sensing apparatus of a tablet auto-dispensing apparatus according to the present invention;

FIG. 5 is a flow chart illustrating a tablet sensing control method of a tablet auto-dispensing apparatus according to the present invention;

FIG. 6 is a block diagram illustrating another embodiment of a tablet sensing apparatus of a tablet auto-dispensing apparatus according to the present invention;

FIG. 7 is a voltage waveform diagram illustrating an initial reference value Vn for determining the change of the amount of light in an initial state before tablets are discharged, according to the present invention;

FIG. 8 is a voltage waveform diagram illustrating a waveform of a pulse supplied to a light emitting device, according to the present invention;

FIG. 9 is a voltage waveform diagram illustrating the change of an initial reference value Vn after a tablet discharging outlet is contaminated, according to the present invention; and

FIG. 10 is a voltage waveform diagram illustrating a waveform of a pulse supplied to a light emitting device through adjustment of the amount of light when the initial reference value Vn is changed by a contaminant as shown in FIG. 9, according to the present invention.

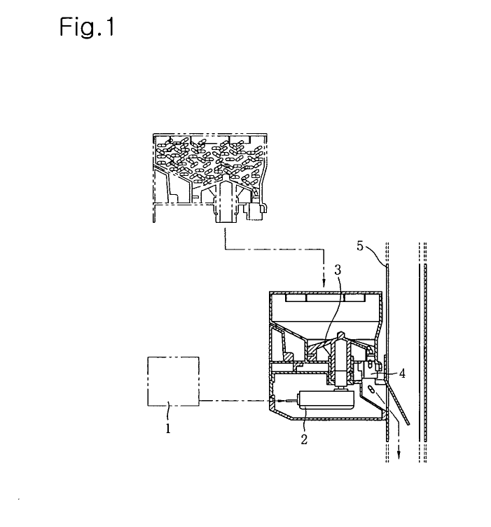

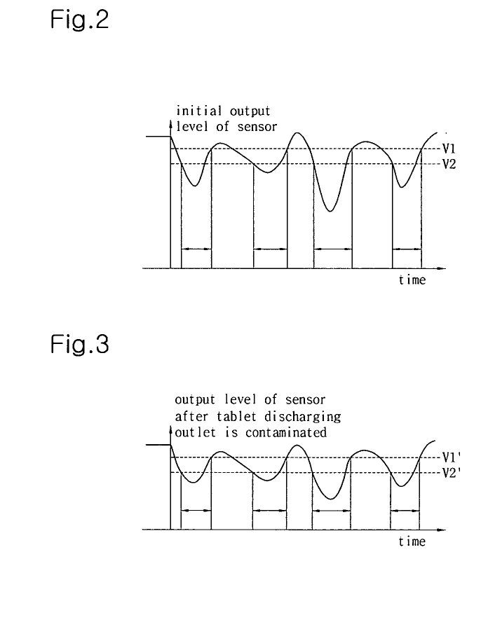

### DESCRIPTION OF THE PREFERRED EMBODIMENTS

Hereinafter, preferred embodiments of the present invention will be described with reference to the accompanying drawings.

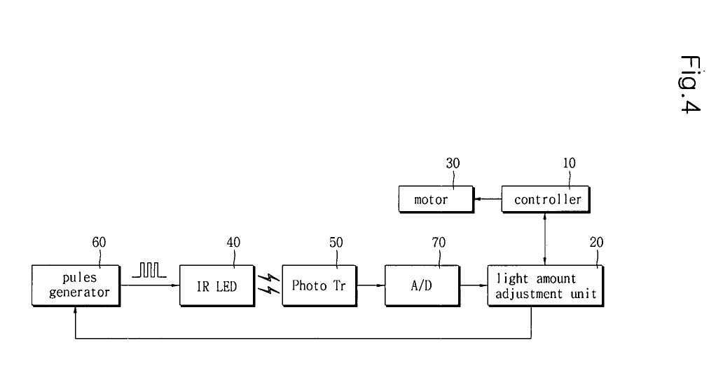

FIG. 4 is a block diagram illustrating an embodiment of a tablet sensing apparatus of a tablet auto-dispensing apparatus according to the present invention.

Referring to FIG. 4, the tablet sensing apparatus comprises a controller 10 for controlling a light amount adjustment unit 20 to automatically adjust the amount of light emitted from a light emitting device (LED) 40 in a tablet sensing sensor when a tablet discharge event occurs and controlling a motor 30 of a corresponding tablet cassette to be driven to discharge the tablets,

the tablet sensing sensor including the light emitting device 40 and a light receiving device (i.e., photo Tr) 50 for outputting an optical signal to a tablet discharge outlet of the tablet cassette and sensing the tablet discharge by detecting the optical signal received through the tablet discharge outlet,

a pulse generator 60 for supplying an operation pulse to the light emitting device 40,

an A/D converter 70 for converting an analog signal received by the light receiving device 50 to a digital signal readable by the controller 10, and

the light amount adjustment unit 20 for determining the amount of change of light by way of a comparison between an output level of the optical signal emitted from the light emitting device 40 and received by the light receiving device 50 and a preset initial reference value Vn of an output level of the optical signal, and adjusting the output level of the optical signal from the light emitting device 40 by the amount of change of light by adjusting a duty cycle of the pulse generator 60.

The controller includes a tablet discharge sensing means for determining whether the tablets are discharged or not by comparing the output level of the optical signal detected by the tablet sensing sensor with a set reference level Vref after the motor is driven to discharge the tablets.

With the tablet sensing apparatus as constructed above, when the change of the amount of light of the tablet sensing sensor is detected before the tablets are discharged, it is attributed to a contaminant, and accordingly, the amount of light is compensated by the amount of change for precise tablet discharge sensing.

When light having predetermined pulse width (on time) supplied from the pulse generator 60 is emitted from the light emitting device 40 and is received by the light receiving device 50 provided in the tablet discharge outlet, some of the light is intercepted by the tablets passing through the tablet discharge outlet. The controller 10 determines whether the tablets are discharged or not based on the change of the level of the optical signal received by the light receiving device 50.

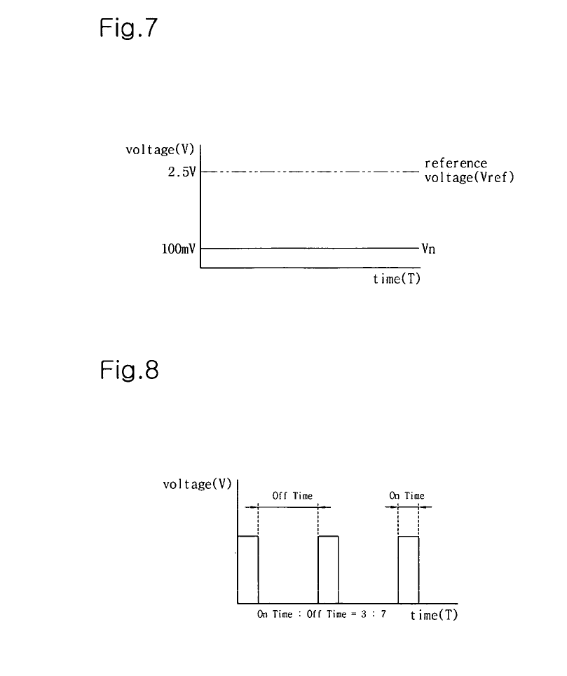

FIG. 7 shows reference voltages, which are set in the light receiving device 50, including a reference value Vref for detecting whether the tablets are discharged or not and an optical signal initial reference value Vn for adjusting the amount of light.

When the tablets are discharged through the tablet discharge outlet, the voltage level of the light receiving device 50 is raised if the light emitted from the light emitting device 40 is intercepted by the tablets. At this time, if the voltage level of the light receiving device 50 is above the reference value Vref of 2.5 V, it is assumed that the tablets have been discharged.

Herein, Vn represents the voltage level of the light receiving device in the most ideal initial state and a voltage applied from the pulse generator 60 to the light emitting device 40 is basically as shown in FIG. 8.

The voltage level of the light receiving device 50 is inversely proportional to a period of on time of the light emitting device 40.

In other words, as the intensity of light emitted from the light emitting device 40 is increased (i.e., as the period of on time is lengthened), the initial reference voltage level Vn becomes lowered.

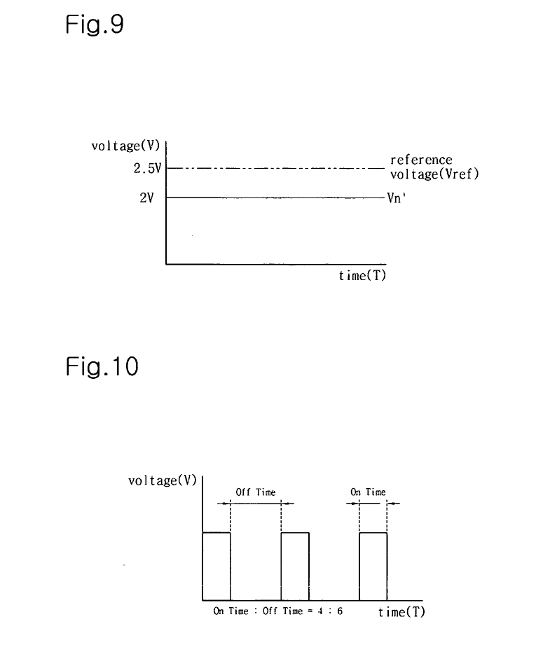

Accordingly, if surfaces of the light receiving device 50 and the light emitting device 40 are contaminated by dust or drug dust, that is, if the intensity of light is lowered due to dust or drug dust, an abnormal initial value Vn′ is measured and continues to rise according to the increased degree of contamination, as shown in FIG. 9. When the abnormal initial value Vn′ is raised above the reference value Vref for detecting whether the tablets are discharged or not, malfunction of the apparatus occurs.

Namely, in spite of the fact that the tablets has not yet been discharged, it may be determined that the tablets have already been discharged.

Accordingly, in the tablet sensing apparatus of the present invention, in order to prevent the malfunction of the apparatus in advance, when the initial value Vn of the light receiving device 50 is measured before the tablets are discharged and the initial value Vn′ is changed above the initial reference value of 100 mV, as shown in FIG. 7, the period of on time of the light emitting device 40 is increased so that the initial value Vn′ is changed to a normal level of the initial reference value Vn. By doing so, the tablets are discharged in a normal manner.

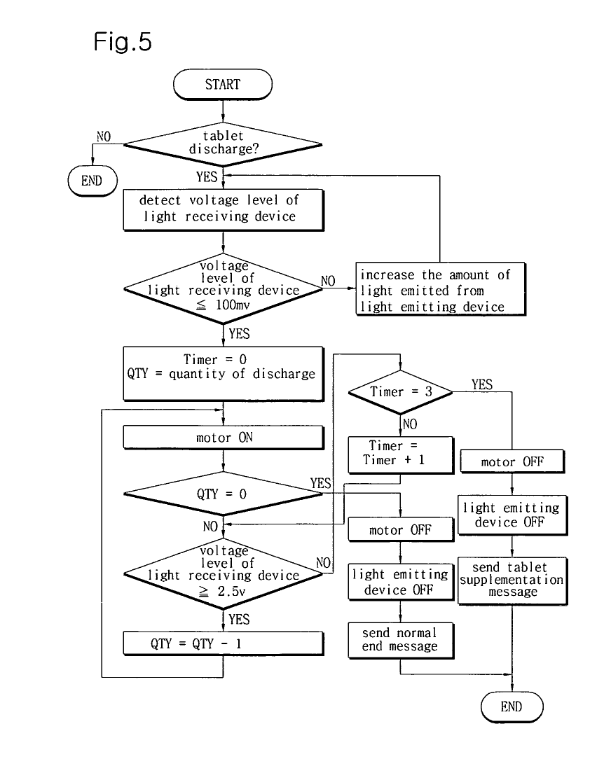

Now, the procedure as described above will be described in more detail with reference to FIG. 5.

When the tablet discharge event occurs, the controller 10 controls the light amount adjustment unit 20 to adjust the amount of light emitted from the light emitting device 40 before the tablets are discharged.

Next, the controller 10 determines the change of the amount of light emitted from the light emitting device 40 by comparing the output level of the optical signal received by the light receiving device 50 and converted to the digital signal through the A/D converter 70 with the preset initial reference value Vn.

As described above, when the output level of the optical signal received by the light receiving device 50 is increased above the initial reference value Vn of 100 mV, it is decreased to the initial reference value Vn of 100 mV by supplying a pulse with the period of on time increased by increasing the duty cycle of the pulse generator 60 to the light emitting device 40.

Thereafter, the controller 10 controls the motor 30 to be driven to discharge the tablets, determines that the tablets are discharged when a voltage above the preset reference voltage Vref is detected, and counts the discharged tablets. When the specified number QTY of tablets are discharged, the motor 30 and the light emitting device 40 are turned off and it is reported that the tablets are properly discharged.

If the voltage level of the light emitting device 50 is not above the reference voltage Vref in spite of the drive of the motor 30, that is, if the tablets are not discharged, the motor 30 and the light emitting device 40 are stopped and a tablet supplementation alarm is generated after a preset period of time (timer=3) elapses.

As one example, the controller 10 can control the light amount adjustment unit 20 periodically, every preset period of time, irrespective of the discharge time of the tablets so that the automatic light amount adjustment process as described above can be performed.

In this way, if the amount of light emitted from the light emitting device 40 and detected before the tablets are discharged is decreased by contaminants such as drug dust, the tablets to be discharged later can be sensed precisely by increasing the amount of light.

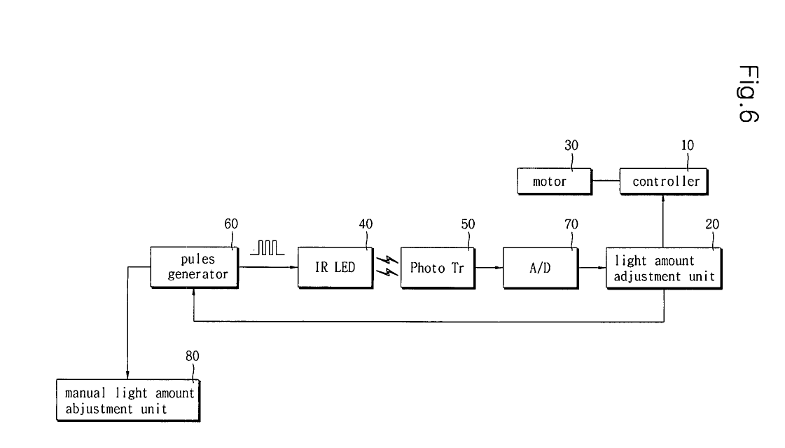

FIG. 6 shows an example of a manual light amount adjustment unit 80, which is a user input means through which a user can directly adjust the amount of light emitted from the light emitting device 40 manually, according to another embodiment of the present invention.

In this embodiment, the manual light amount adjustment unit 80 is used to adjust the pulse duty cycle of the pulse generator 60, and consequently, the amount of light emitted from the light emitting device 40 periodically or at a user's need, so that the intensity of light received by the light receiving device 50 can be adjusted.

As is apparent from the above description, the tablet sensing apparatus of the present invention can easily overcome the problem that light is not detected precisely if the light emitting device or the light receiving device of the tablet sensing sensor is covered with drug dust and the like, and consequently, can increase the sensing precision of the tablet discharge.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A tablet discharge sensing apparatus of a drug dispensing apparatus, including a tablet discharge means for discharging tablets contained in a container, a motor for driving the tablet discharge means, and a control means for controlling the motor of a corresponding tablet cassette to discharge the tablets when a tablet discharge event occurs, wherein the tablet discharge sensing apparatus further comprises:
an optical sensing means including a light emitting device and a light receiving device for outputting an optical signal to a tablet outlet and detecting the optical signal received through the tablet outlet, and
a light amount adjustment means for determining the amount of change of light by way of a comparison between an output level (Vn′) of the optical signal detected by the optical sensing means and an initial reference value (Vn) of a preset output level of the optical signal, and adjusting the output level of the optical signal from the light emitting device by the amount of change of light, and
wherein the control means controls the tablet discharge after adjusting the output level of the optical signal from the light emitting device through the light amount adjustment means when the tablet discharge event occurs, and compares the output level of the optical signal detected by the optical sensing means with a set reference level (Vref) for sensing the tablets to be discharged.

2. The tablet discharge sensing apparatus as set forth in claim 1, further comprising a manual light amount adjustment unit, which is a user input means through which a user can directly adjust the amount of light emitted from the light emitting device manually.

3. The tablet discharge sensing apparatus as set forth in claim 1 or 2, wherein the light amount adjustment means and the manual light amount adjustment unit adjust the amount of light emitted from the light emitting device by adjusting a duty cycle of a driving pulse supplied to the light emitting device.

4. A tablet discharge sensing control method for a drug dispensing apparatus, including discharging tablets contained in a corresponding tablet cassette when a tablet discharge event occurs, and sensing the discharged tablets to determine whether the tablets are discharged in a normal state, the method comprising the steps of:
detecting a level (Vn′) of an optical signal emitted from a light emitting device of the corresponding tablet cassette and received in a light receiving device when a tablet discharge event occurs;
determining the change of the amount of light by comparing the level (Vn′) of the optical signal detected by the light receiving device with an initial reference value (Vn) of a level of the optical signal emitted from the light emitting device,
adjusting the amount of light emitted from the light emitting device for the change of the amount of light based on the initial reference value (Vn) when the amount of light is changed; and
sensing the tablet discharge by discharging the tablets and determining whether the tablets are discharged or not by comparing the level of the optical signal detected by the light receiving device with a preset reference value (Vref).

5. The tablet discharge sensing control method as set forth in claim 4, further comprising detecting the optical signal before the tablets are discharged, and determining the change of the amount of light from the detected optical signal to adjust the amount of light, periodically every a preset period of time.
